(19) United States
(12) Patent Application Publication
(10) Pub. No.: US 2012/0160184 A1
(43) Pub. Date: Jun. 28, 2012

(54) Animal Harness

(76) Inventor: Jerry Lichvar, Gold Hill, OR (US)

(21) Appl. No.: 12/976,631

(22) Filed: Dec. 22, 2010

(51) Int. Cl. A01K 27/00; A01K 29/00

(52) U.S. Cl. 119/725

(57) ABSTRACT

The present invention teaches of a multi-functional animal harness and carrier comprising of a front harness and an aft harness section. The front harness section comprise of a plurality of shoulder straps and an intermediate strap that secures the harness to the animal. The front harness section can be used independently when the secured animal is on its own feet. When the animal is to be lifted and carried about, the aft harness may be affixed to the front harness section to support the ladder part of the animal. The aft harness comprise of elastic straps that allows the hind section of a suspended animal to suspend lower than the front thus contributing to the comfort of the animal. The shoulder harness section and aft harness section may be extended by an extension panel section.

### FIELD OF INVENTION

This invention relates generally to an animal harness, and more particularly to an improved multi sectional harness that is multifunctional as a restraint device and as an animal carrier.

### BACKGROUND OF THE INVENTION

There are a wide variety of animal harnesses which have been commonly available or which have been patented over the years. Generally, the type of prior art harnesses can be divided into two categories. The first typically comprises of a shoulder harness apparatus that waiver from standardized neck collars. These harnesses will wrap around the pets shoulders, chest and front legs and prevent injuries or stress to the pet's neck. This is especially true for smaller animals.

For example, U.S. Pat. No. 5,913,285 by Prichard and U.S. Pat. No. 6,101,979 by Wilson both teach of a non-choking pet restraint which applies restraining pressure to an animal's shoulder and neck. Both devices have a chest and belly panel that is secured by multiple straps and buckles. Although this harness is adequate in restraining an animal while the animal is on the ground, it will not properly support a suspended animal.

U.S. Pat. No. 7,357,099 by Moore and U.S. Pat. No. 7,757,641 by Worden both teach of an animal shoulder harness made to assist the mobility of elder animals. The harnesses are designed to help the human handler of the animal apply counter weight when the animal is mobile. However, neither patent allows the handler to lift and carry the animal for a long period of time or safely support a suspended animal.

The second type of harnesses well known in the art are those that function as an animal sling, whereby the harness can fully support a suspended smaller animal and facilitate the transportation of the animal. For example, U.S. Pat. No. 4,559,906 by Smith teaches of a small animal harness that essentially wraps around or under the trunk of the small animal. The harness includes straps that fasten together across the back of the animal and a handle that is affixed to the straps in the area of the animal's back to enable the animal to be manually picked up and carried about. Although Smith allows the animal to be fully suspended, it is not multi-sectional, and does not allow the handler to convert the harness into a standard shoulder harness for when the animal is on the ground.

U.S. Pat. No. 4,644,902 by Doyle teaches a pet carrier comprising a body portion, having four leg openings for the animal's legs to extend through, and integral straps extending from opposing sides of the body portion. The straps are brought together whereby the carrier is formed into a sling for the animal with its legs protruding through the leg openings. Once again, this invention is not multi-sectional and does not allow the carrier to be used as a harness for when the animal is not suspended.

U.S. Pat. No. 5,193,486 by Kitchens shows a pet jacket-carrier having a flexible bag-like body member which includes a torso support portion, a neck loop, carrying handles, a rear leg support pocket, and a hind legs support portion. A neck brace is attached to the open forward end, and a pair of strap handles are attached to respective sides of the body member. A slit extends along the top of the body member which can be opened and closed by a zipper. Like the other carrier prior art, Kitchens does not teach of a harness that is multi-sectional and multifunctional as a carrier and a harness.

U.S. Pat. No. 5,894,817 by Manuel and U.S. Pat. No. 6,802,282 by Muckleroy both teach of a pet carrier that comprise of a pair of left and right side panels extending from a center bottom panel. Both prior art focus exclusively on the support and carrying of the animal but once again, they do not provide alternatives when the animal is traveling on its own.

U.S. Pat. No. 5,845,606 by Hartman and U.S. Pat. No. 7,284,504 by Purschwitz teach of an animal harness that are essential four straps that secure the front and back legs of the animal and is connected by a central strap that is positioned on the back of the animal. The harnesses are neither multi-sectional nor are designed to support a suspended animal for a long period of time. These prior art forces all the pressures on a small area of the animal's body near the front and hind legs and fails to provide adequate chest and abdomen support for a suspended animal.

It is apparent that the known art harnesses and carriers have many well-known deficiencies. None of the harnesses are multi-sectional and multifunctional. They are either designed only as a collar alternative or as a means to support a suspending animal.

What is needed, then, is an animal restraint harness wherein the harness itself is multifunctional. An animal harness is needed that is easily adjustable and multi-sectional which provides different uses depending on what section of the harness is being used.

Accordingly, it is an object of the invention to provide an animal harness which safely restrains a pet without applying acute pressure at any one point of the pet's body.

It is a further object of the invention to provide alternative use of the harness depending on the sections utilized. Each section may be used independently to restrain an animal, while the option is present to add additional sections to fully support the animal for carrying.

It is a further object of the invention that the animal harness also provides physical protection to the dog's neck, chest and abdomen area from obstacles encountered in the field, such as sticks and branches. These and other objects and advantages of the present invention will be more readily apparent from a consideration of the following drawings and a detailed description of the preferred embodiment.

### SUMMARY

It is therefore an object of the present invention to overcome the aforementioned disadvantages of prior art devices and provide a relatively inexpensive multi-sectional harness that provides the versatility of being a collar alternative restraining harness and a support harness capable of fully supporting a suspended animal for transportation. The present invention teaches of a harness system that is multi-sectional where some sections may be used independently. The present invention comprises of a front harness section, an aft harness section and an optional extension panel section. The front harness comprises of a chest panel with a front end and back connection end. A plurality of shoulder straps is connected to the front of the chest harness and may be used to secure the chest panel to the animal. An intermediate strap is connected to the mid section of the chest panel and may wrap around the animal's torso, thus further securing the chest panel to the animal.

The front harness may be used independently to restrain the animal while the animal is on the ground. However, when the animal is to be suspended and carried about, the aft harness may be attached to the front harness. The aft harness comprises of an abdomen panel with a front connection end and a rear end. A plurality of elastic straps is affixed to the rear end of the abdomen panel to properly balance the suspended animal allowing the animal's hind section to rest lower than the animal's front section. The plurality of elastic straps may be connected to the front harness along the animal's back. The front connection end of the aft harness may be affixed to the back connection end of the front harness to allow the joining of the chest and abdomen panel. Additional side straps may be affixed to the abdomen panel and vertically affix the aft harness to the back of the animal. An optional extension panel may be used to bridge the front and aft harness to increase the length of the harness as a whole.

These and other novel features and advantages of the invention will be described in greater detail in the following detailed description.

### BRIEF DESCRIPTION OF THE DRAWINGS

The above description and other objects, advantages, and features of the present embodiment will be more fully understood and appreciated by reference to the specification and accompanying drawings, wherein:

FIG. 1 is top view of the preferred embodiment harness system unassembled.

FIG. 2 is a bottom view of the preferred embodiment harness system unassembled.

FIG. 3 is a top view of the preferred embodiment harness system fully assembled.

FIG. 4 is a front view of the front harness of the preferred embodiment as seen on a dog.

FIG. 5 is a side view of the front harness of the preferred embodiment as seen on a dog.

FIG. 6 is a side view of a dog suspended by the preferred embodiment harness system with both the front harness and the aft harness.

### DETAILED DISCUSSION OF THE PREFERRED EMBODIMENTS

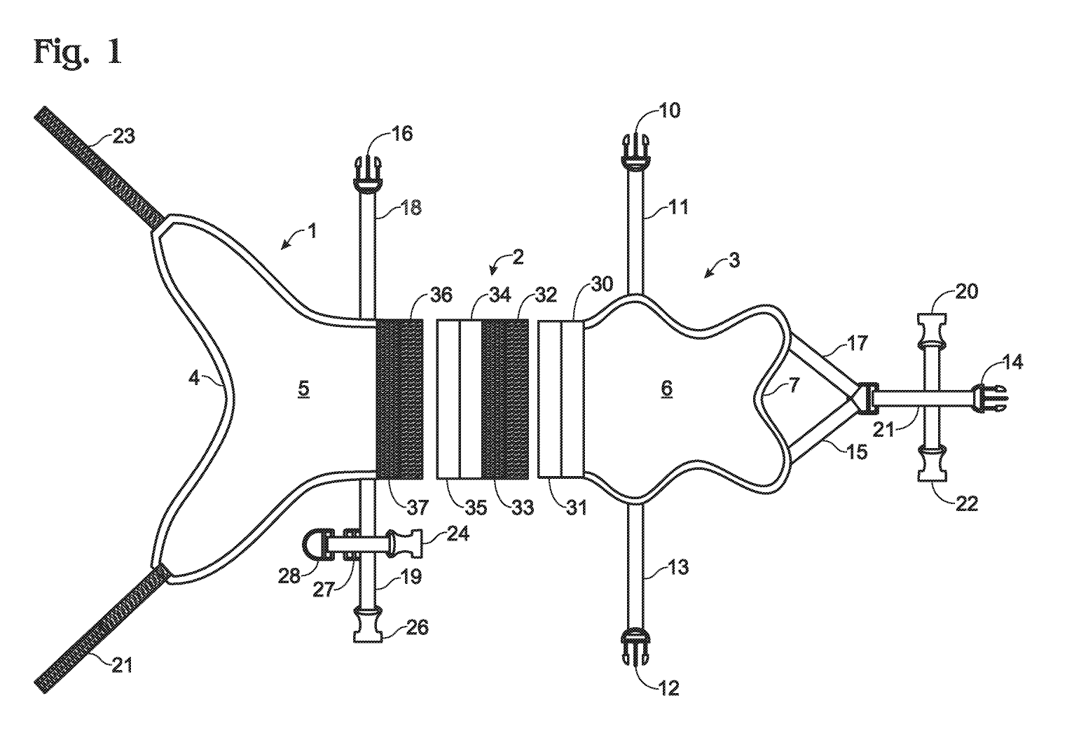

The present invention is directed to an effective multi-sectional adjustable harness for animals. In FIG. 1 an animal harness system 40 is illustrated in its uninstalled state in accordance to the preferred embodiment. FIG. 1 is the top view of the harness system 40 comprising of three sections. The front harness is identified as section 1 and can be used independently to restrain an animal while the animal is on the ground. The aft harness is identified as section 3 and can be connected to section 1 to form a full body harness that allows the animal to be suspended and carried. The central extension section 2 is optional and may be used to extend the length of the harness dependent on the size of the animal.

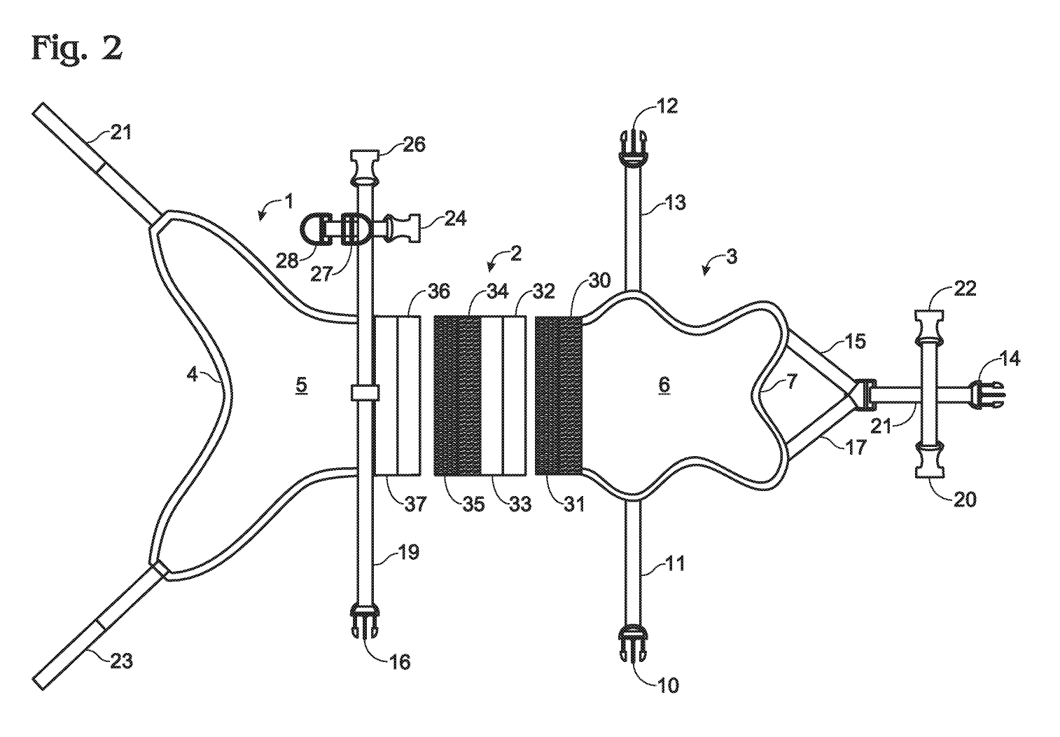

In the preferred embodiment, the front harness 1 comprises of a padded chest panel 5 with a fin shaped front end and back connection dual velcro end with velcro receptors panel 36 and velcro receiver panel 37. If the front harness 1 is used independent of the aft harness 3, then velcro panel 36 may be folded onto velcro panel 37 to hide the velcro receptors thus keeping them from irritating the soft abdomen of the animal. Attached at the tip of each fin are front shoulder straps 21 and 23. The front shoulder straps 21 and 23 each comprise of both velcro receptors and velcro receivers thus allowing each strap to be folded upon itself. In the preferred embodiment, the velcro on the front shoulder straps 21 and 23 are on the bottom side and can be seen in FIG. 2.

FIG. 2 also shows the intermediate strap 19 slideably connected to the bottom side of the front harness section 1. Intermediate strap 19 comprises of two ends wherein the first end is adjustably connected to a male snap buckle 16 and the second end is cross sectional and further comprises female snap buckles 24 and 26 and anchor rings 27 and 28.

When the front harness is used independently to restrain the animal, the shoulder straps 21 and 23 are extended up and above the animal's shoulders and threaded through the anchor ring 28. The length of straps 21 and 23 are determined by the length of which the strap is folded upon itself. Intermediate strap 19 is wrapped around the front torso of the animal and secured when the male snap buckle 16 is snapped into female snap buckle 26. In the preferred embodiment, the end of strap 19 that connects to male snap buckle 16 comprise of both velcro receptors and receivers and once again the length of the strap is adjustable by altering the overlay of strap 19 through male snap buckle 16. Once the front harness is fully secured and the lengths of the straps are adjusted, a leash can be connected to anchor 27 and the animal can be restrained while on the ground.

Although the front harness has independent utility, the present invention also teaches of a means to add on to front harness 1 to allow the animal to be fully supported in situations where its handler would like to carry the animal. The aft harness section 3 comprises of a padded panel 6 with a smaller wave shaped aft end 7 and a front connecting end comprising of velcro receiver panel 30 and velcro receptor panel 31. In the preferred embodiment, the velcro receivers and receptors on panels 30 and 31 are located on the bottom side of the abdomen panel. The front connection end of the abdomen panel may be affixed over the back connection end of the chest panel when both sections of the harness are being used without the extension panel.

The aft harness 3 has on its wave shaped end, two rear elastic straps 15 and 17 connected to the anchor ring 29. Anchor ring 29 is then connected to a cross sectional strap 21 further comprising two female snap buckles 20, 22 and a male snap buckle 14. On either side of the abdomen panel 6 are straps 11 and 13 wherein strap 11 is adjustably secured to male snap buckle 10 and strap 13 is adjustability secured to male snap buckle 12. The velcro section 30 and 31 can directly connect to velcro section 36 and 37 of the front harness section or if additional length is needed, an extension panel section 2 can be used to bridge the front and aft harness. When the front and aft harness are affixed together by velcro, none of the velcro receptors or receivers on the chest and abdomen panels are exposed to irritate the animal.

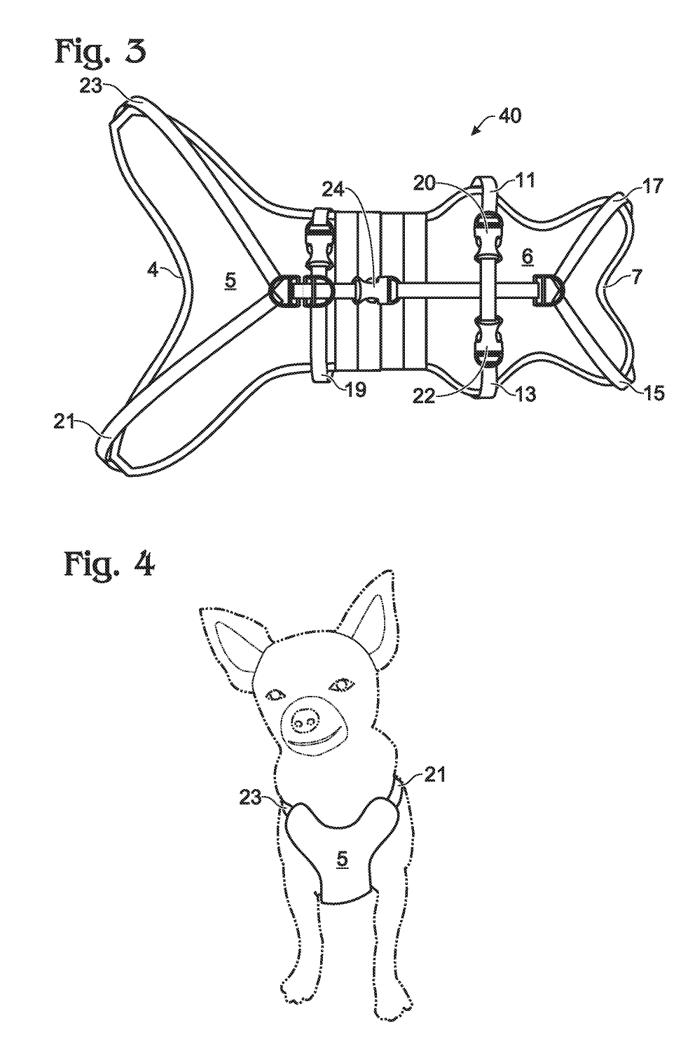

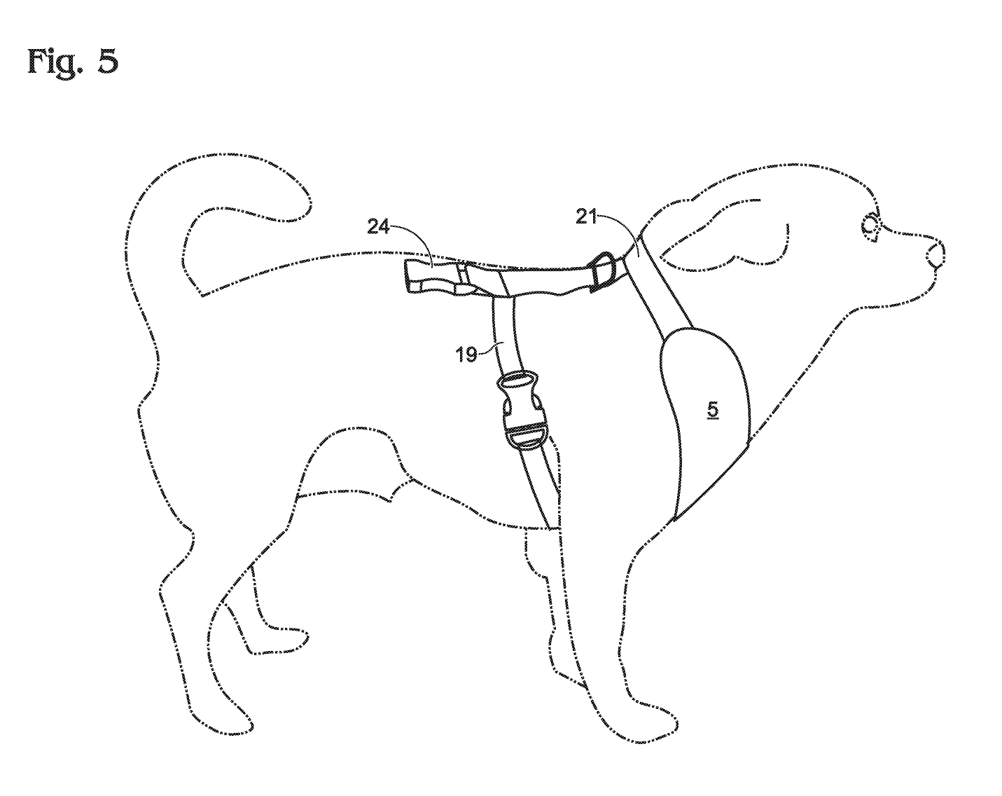

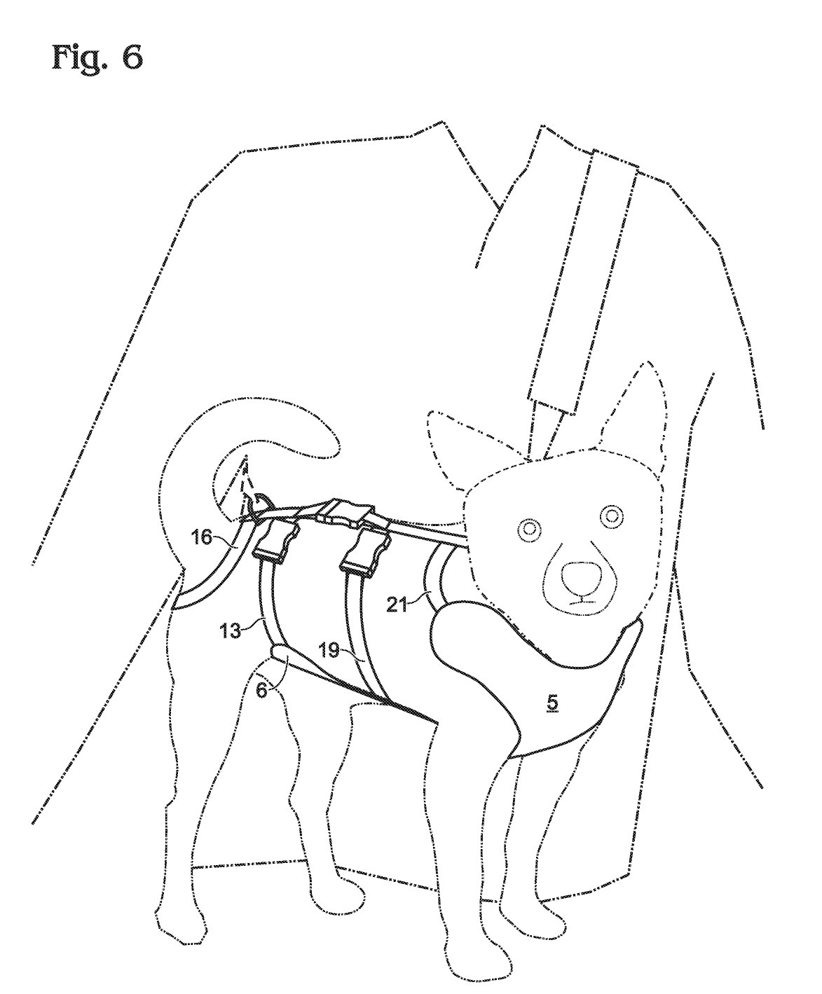

FIG. 3 shows the harness 40 assembled and FIG. 4-6 shows the harness secured to a dog. When securing the entire harness around an animal, the front harness 1 is secured the same as when it is used independently. The animal's front legs are positioned in-between straps 21 and 19, and 23 and 19. The animal's rear legs are positioned in-between straps 15 and 13, and straps 11 and 17. The animal's tail, if applicable, is positioned between elastic straps 15 and 17. The smaller wave shaped end of the abdomen panel 6 is shaped and sized to avoid the animal's genitals thus allowing the animal to relieve itself without soiling the harness. The aft harness is secured by wrapping straps 11 and 13 around the lower torso of the animal and securing the position of the straps by snapping male snap buckle 10 into female snap buckle 20 and male snap buckle 12 to female snap buckle 22. Male snap buckle 14 will connect to female snap buckle 24 thus connecting the front harness 1 and aft harness 3 along the back of the animal. An elongated flexible shoulder strap 7 may be used to connect to anchor ring 29 and anchor ring 27 thus allowing the animal's human handler to sling and carry the animal under his shoulder and allow easy and effortless transportation of the animal. When the animal is suspended within the harness, the elastic straps 15 and 17 allows the animal's hind side to rest lower than the front side, which significantly contributes to the comfort of the animal. The elasticity of straps 15 and 17 also provides balancing of the animal while suspended and absorbs the movement of the human handler during transportation.

In the preferred embodiment, all the male snap buckles are secured to its corresponding straps by velcro. Each strap comprises of both velcro receptors and receivers and the straps are inserted into the buckles and folded upon itself to secure the buckles to the end of the straps. Once again, the length of the straps can be easily adjusted depending on the length of the strap folded upon itself. The front panel 5 and aft panel 6 comprise of a breathable nylon material on the top side to provide comfort and warmth to the animal and a harder nylon material on the bottom side to protect the animal from brush, rocks and other harmful material.

Throughout the specification the aim has been to describe the invention without limiting the invention to any one embodiment or specific collection of features. Persons skilled in the relevant art may realize variations from the specific embodiment that will nonetheless fall within the scope of the invention. For example, sections 1 and 3 may be connected by means other than velcro. The length of the straps found through out the harness 40 can be adjusted by means other than velcro. The shapes of the panel 5 and 6 are not limited to the preferred embodiment and the panels can be made with any material capable of supporting a suspended animal. The quick snap buckles used in the preferred embodiment can be replaced with any other means of connecting the straps of the harness.

Accordingly, the scope of the invention should be determined not by the embodiment illustrated, but by the appended claims and their legal equivalents.

I Claim:

1. An adjustable multi-sectional animal harness and animal carrier comprising:
a. a front harness and an aft harness;
b. said front harness further comprises of a chest panel with a front end and a back connection end, a plurality of front shoulder straps connected to the said front end of the said chest panel, a intermediate strap connected to the bottom of said chest panel;
c. said aft harness further comprises of an abdomen panel with a front connection end and a back end, wherein the said front connection end of the said aft panel may be affixed to the said back connection end of the said chest panel;
d. a plurality of flexible rear straps with one end connected to the said back end of the said abdomen panel and the other end connectable to the said intermediate strap of the said front harness thus connecting the front and back harness along the back of the animal.

2. The adjustable multi-sectional animal harness and animal carrier of claim 1 further comprising an extension panel capable of lengthening and bridging the said chest panel and said abdomen panel along its connection ends.

3. The adjustable multi-sectional animal harness and animal carrier of claim 2 wherein the said extension panel connects to the chest panel and abdomen panel by velcro.

4. The adjustable multi-sectional animal harness and animal carrier of claim 1 wherein the said front end of the said chest panel is fin shaped and the said connection end comprise a plurality of velcro straps capable of folding onto itself when the front harness is used independent of the said aft harness thus concealing all exposed velcro receptors.

5. The adjustable multi-sectional animal harness and animal carrier of claim 1 wherein the said intermediate strap:
a. is slideably attached to the chest panel;
b. one end of the said intermediate strap is attached by velcro to a male snap buckle and the other side of said intermediate strap comprise of a cross sectional end with a plurality of female snap buckles and a plurality of anchor rings; and
c. wherein the said intermediate strap may be wrapped around the torso of the animal and secured by the said male and female snap buckle of the intermediate strap.

6. The adjustable multi-sectional animal harness and animal carrier of claim 5 wherein the said plurality of front shoulder straps each comprise of both velcro receivers and receptors and the said plurality of front shoulder straps are secured to at least one of the said anchor rings found on the said intermediate strap.

7. The adjustable multi-sectional animal harness and animal carrier of claim 6 further comprising:
a. a plurality of side straps with one side connected to the abdomen panel and the other end adjustably connected to a male buckle;
b. the said flexible rear straps are attached to rear cross sectional strap with a male buckle capable of connecting to the said female buckle on the said intermediate strap and a plurality of female buckles capable of securing the male buckles on the said side straps found on the said aft harness.

8. The adjustable multi-sectional animal harness and animal carrier of claim 1 wherein the back end of the said abdomen panel is wave shaped and sized to expose the genitals of the animal being secured.

9. The adjustable multi-sectional animal harness and animal carrier of claim 1 wherein the said chest and aft panels are made of a synthetic material.

10. The adjustable multi-sectional animal harness and animal carrier of claim 1 wherein the top side of the said chest and aft panels are made of a soft breathable material and the bottom side of the said chest and aft panels are made of a tear resistant material.

11. The adjustable multi-sectional animal harness and animal carrier of claim 1 wherein the rear elastic straps allow the aft section of the animal to rest lower than the front section of the animal while the said animal is suspended.

12. The adjustable multi-sectional animal harness and animal carrier of claim 1 further comprising an adjustable shoulder strap attachable to the front and aft harness thus allowing the harnessed animal to be carried under the shoulder of a human handler.
